(19) United States
(12) Patent Application Publication
(10) Pub. No.: US 2002/0112126 A1
(43) Pub. Date: Aug. 15, 2002

(54) Cache memory system

(75) Inventors: Fumihiko Hayakawa, Kawasaki (JP); Hiroshi Okano, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/017,317

(22) Filed: Dec. 18, 2001

(30) Foreign Application Priority Data
Feb. 13, 2001 (JP) 2001-035175

(51) Int. Cl. G06F 13/00

(52) U.S. Cl. 711/128

(57) ABSTRACT

In the cache memory system, tag memory RAM modules and cache memory RAM sections each capable of switching a state between an ordinary state and a low consumption power state are connected in parallel. An n-way set associative constitution in which all the tag memory RAM modules and all the cache memory RAM modules are activated in the ordinary state, is switched to/from a 1-way direct map constitution in which only a pair of the tag memory RAM module and the cache memory RAM module are activated in the ordinary state and the remaining tag memory RAM modules and cache memory RAM modules are turned into the low consumption power state based on a value of a request address, according to a power mode signal.

### FIELD OF THE INVENTION

The present invention relates to a cache memory system capable of dynamically switching a construction between a set associative constitution and a direct map constitution.

### BACKGROUND OF THE INVENTION

In a data arithmetic processing unit including therein a cache memory system such as a microprocessor, there are provided a set associative constitution and a direct map constitution as the constitution of the cache memory system. In a same memory capacity, since the cache memory system of the set associative constitution has a high hit ratio than that of a cache memory of the direct map constitution, it is expected that the performance of the arithmetic processing unit is improved. The set associative constitution has, however, a disadvantage of high power consumption.

The constitution of a conventional cache memory system of a set associative constitution will be described. It is noted that description will be given to a cache memory system having a 4-way constitution, a cache memory capacity of 16 Kbytes, a cache memory line size of 64 bytes and the number of the entries of each way of 64.

FIG. 1 is a block diagram showing a conventional cache memory system of a set associative constitution. Because of a 4-way constitution, this cache memory system has four tag memory RAM modules 11a, 11b, 11c and 11d connected in parallel and four cache memory RAM modules 12a, 12b, 12c and 12d connected in parallel. In addition, the cache memory system has a tag determination circuit 13 and a data selector 14. The tag determination circuit 13 consists of four comparators 15a, 15b, 15c and 15d and four AND circuits 16a, 16b, 16c and 16d.

The tag memory RAM modules 11a, 11b, 11c and lid store data indicating the addresses of data stored in the corresponding cache memory RAM modules 12a, 12b, 12c and 12d and entry valid flags (entry valid) indicating whether or not the address data are valid, respectively.

The cache memory RAM modules 12a, 12b, 12c and 12d store data used in arithmetic processing or the like performed by a processor core or the like, not shown, respectively. Each of the tag memory RAM modules 11a, 11b, 11c and lid and the cache memory RAM modules 12a, 12b, 12c and 12d has a function of turning each of the entire RAM module or a part of each of the data input/output circuit in the RAM module into a low consumption power state.

The tag determination circuit 13 compares an address value requested by the processor core or the like (which address value will be referred to as “request address” hereinafter) with address data read from each of the tag memory RAM modules 11a, 11b, 11c and 11d, and determines whether they are coincident or not. The respective comparators 15a, 15b, 15c and 15d of the tag determination circuit 13 compare the request address with the address data, and make determinations.

The data selector 14 selects only valid data from among the data read from each of the cache memory RAM modules 12a, 12b, 12c and 12d and output the selected data to a data bus. The respective AND circuits 16a, 16b, 16c and 16d in the tag determination circuit 13 output control signals for allowing the data selector 14 to select valid data based on their entry valid flags. Namely, the data selector 14 selects valid data based on the control signals outputted from the AND circuits 16a, 16b, 16c and 16d, respectively.

The function of the conventional cache memory system shown in FIG. 1 will be described. First, the function thereof at the time of reading data will be described. When the request address of read data is input from the processor core or the like, address data corresponding to the request address and entry valid flags corresponding to the address data are read from the tag memory RAM modules 11a, 11b, 11c and 11d, respectively. The corresponding comparators 15a, 15b, 15c and 15d compare the address data thus read with the request address and determine whether or not the read address data are coincident with the request address, respectively.

The determination results of each of the comparators 15a, 15b, 15c and 15d as well as the entry valid flags of the corresponding ways are input into the corresponding AND circuits 16a, 16b, 16c and 16d, respectively. The outputs of each of the AND circuits 16a, 16b, 16c and 16d are supplied, as control signals for the data selector 14, to the data selector 14. Based on the control signals, only the way storing the address data determined to be coincident with the request address and to be valid by the entry valid flag becomes valid among the address data read from each of the tag memory RAM modules 11a, 1b, 11c and 11d.

On the other hand, from each of the cache memory RAM modules 12a, 12b, 12c and 12d, data corresponding to the request address are read based on the input of the request address. Among the read data, only the data read from the cache memory RAM module on the way determined to be valid by the data selector 14 is outputted to the data bus. Also, the outputs of each of the AND circuits 16a, 16b, 16c and 16d are supplied, as cache hit/miss signals, to the processor core or the like.

Next, the function of the time of writing data will be described. When writing data, a request address is written to the tag memory RAM module for an entry selected based on the address of a way, to which the data is to be written, and the data is written to the cache memory RAM module.

However, in the conventional cache memory system having a set associative constitution as stated above, it is necessary to drive the tag memory RAM modules and the cache memory RAM modules on all the ways at the time of reading data from the cache memory. Due to this, the conventional cache memory system has a problem in that more power is required than that of a cache memory system having a 1-way constitution, i.e., a direct map constitution even with the same memory capacity.

### SUMMARY OF THE INVENTION

It is an object of this invention to provide a cache memory system capable of dynamically switching a mode between a high hit ratio mode with a set associative constitution and a low consumption power mode with a direct map constitution.

In the cache memory system according to this invention, n tag memory RAM sections each capable of switching a state between an ordinary state and a low consumption power state are connected, for example, in parallel, n cache memory RAM sections each capable of switching a state between the ordinary state and the low consumption power state are connected, for example, in parallel, and a RAM section connection structure is dynamically switched between an n-way constitution and a 1-way constitution by RAM power control unit according to a power mode.

That is to say, if a power mode signal input from externally is in a high hit ratio mode, the cache memory system is controlled, by the RAM power control unit, to have a set associative constitution in which all the tag memory RAM sections and all the cache memory RAM sections are activated in the ordinary state. With this constitution, the data selector selects only data read from the cache memory RAM section corresponding to a way on which the address data read from each of the tag memory RAM section is coincident with the value of a request address supplied from a processor core or the like.

On the other hand, if the power mode signal input from externally is in a low consumption power mode, the cache memory system is controlled, by the RAM power control unit, to have a 1-way direct map constitution in which only one of the tag memory RAM sections and only one of the cache memory RAM sections corresponding to the tag memory RAM section are activated in the ordinary state and the remaining tag memory RAM sections and cache memory RAM sections are turned into the low consumption power state based on the value of the request address supplied from the processor core or the like. With this constitution, the data selector selects only data read from the cache memory RAM section in the ordinary state.

According to this invention, if the power mode signal is in a high hit ration mode, the cache memory system is activated as a system having an n-way set associative constitution. On the other hand, if the power mode signal is in a low consumption power mode, the cache memory system is activated as a system having a 1-way direct map constitution. It is, therefore, possible to select a case where the performance of the arithmetic processing unit is prioritized even if power consumption is high and a case where low consumption power is prioritized, according to a user or a peripheral environment such as an application in use.

Other objects and features of this invention will become apparent from the following description with reference to the accompanying drawings.

### BRIEF DESCRIPTION OF THE DRAWINGS

FIG. 1 is a block diagram showing a conventional cache memory system having a set associative constitution;

FIG. 2 is a block diagram typically showing the important parts of an example of an entire system including a cache memory system according to the first embodiment that realizes the present invention;

FIG. 3 is a block diagram typically showing the important parts of another example of an entire system including a cache memory system according to the first embodiment;

FIG. 4 is a block diagram showing an example of the cache memory system according to the first embodiment;

FIG. 5 is a logic circuit diagram showing an example of the RAM power control device of the cache memory system according to the first embodiment;

FIG. 6 is a logic circuit diagram showing an example of the data selector control circuit of the cache memory system according to the first embodiment;

FIG. 7 is a logic circuit diagram showing an example of the cache hit/miss control circuit of the cache memory system according to the first embodiment;

FIG. 8 is a typical view for describing the concept of the memory regions of the cache memory system according to the first embodiment;

FIG. 9 is a block diagram showing an example of a cache memory system according to the second embodiment that realizes the present invention;

FIG. 10 is a block diagram showing an example of a cache memory system according to the third embodiment that realizes the present invention;

FIG. 11 is a block diagram showing another example of a cache memory system according to the third embodiment;

FIG. 12 is a block diagram showing another example of a cache memory system according to the third embodiment; and

FIG. 13 is a block diagram showing another example of a cache memory system according to the third embodiment.

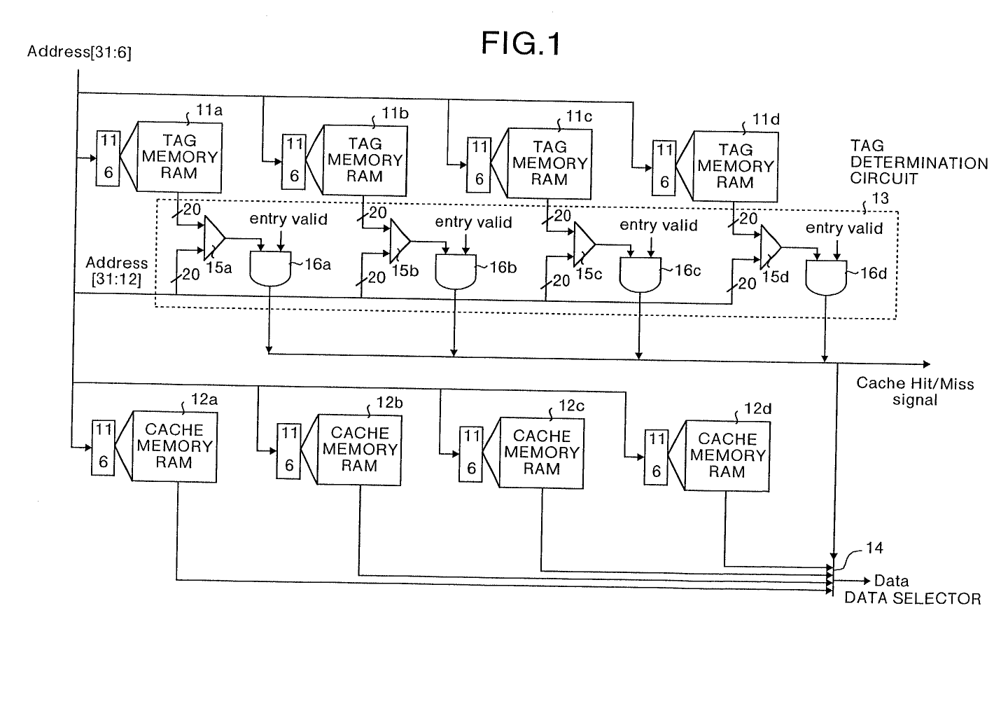

### DESCRIPTION OF THE PREFERRED EMBODIMENTS

Embodiments for realizing the present invention will be described hereinafter in detail with reference to the drawings. It is noted that the embodiments will be described while assuming that, though not specially limited thereto, a cache memory system has a 4-way constitution, a cache memory capacity of 16 Kbytes, a cache memory line size of 64 bytes and the number of the entries of each way of 64.

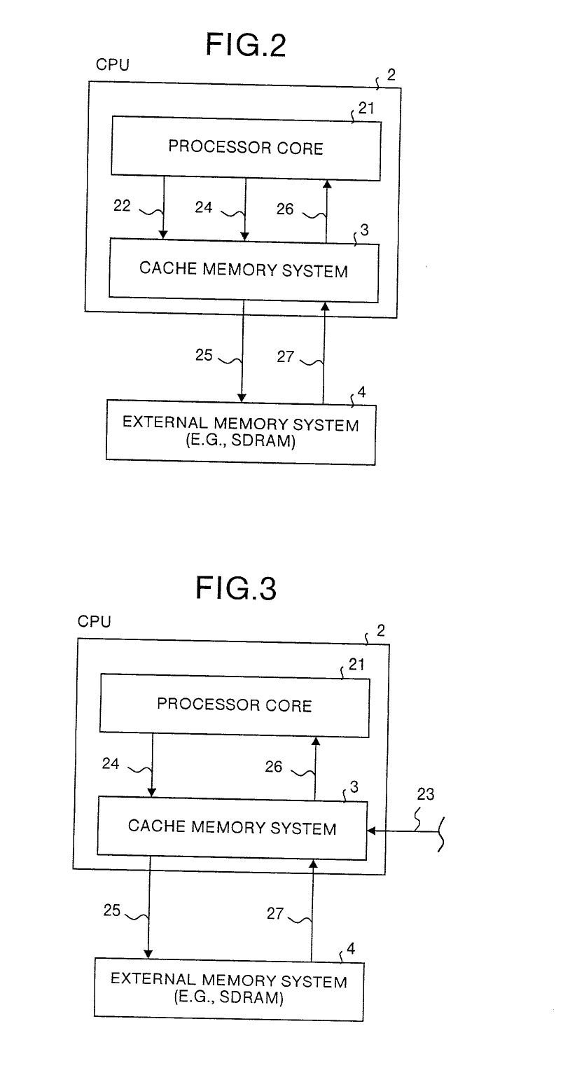

FIGS. 2 and 3 are block diagrams typically showing the important parts of an example of an entire system including a cache memory system according to the first embodiment for carrying out the invention. An arithmetic processing unit (CPU) 2 includes therein a processor core 21 and a cache memory system 3 and the unit 2 is connected to an external memory system 4.

In the example shown in FIG. 2, the cache memory system 3 is supplied with a power mode signal 22 from the processor core 21. In case of FIG. 3, by contrast, a cache memory system 3 is supplied with a power mode signal 23 from externally by user's setting of the other system, such as a power supply management system, utilizing an arithmetic processing unit 2, a dip switch or the like. Here, the power mode signals 22 and 23 are signals indicating that the cache memory system 3 is set to have a set associative constitution or a direct map constitution. In FIGS. 2 and 3, reference symbols 24 and 25 denote address signals and reference symbols 26 and 27 denote data.

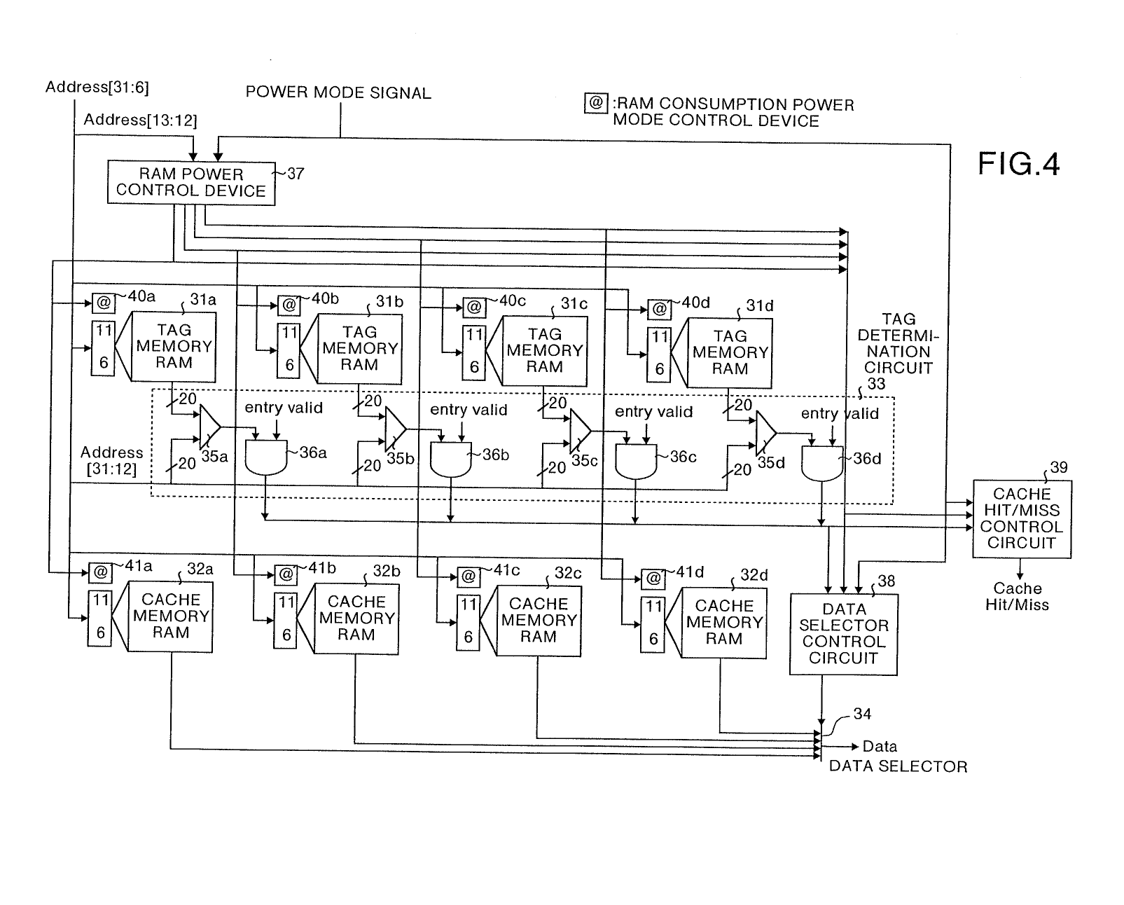

FIG. 4 is a block diagram showing an example of a cache memory system according to the first embodiment for carrying out the present invention. Because of a 4-way constitution, this cache memory system has four tag memory RAM modules 31a, 31b, 31c and 31d connected in parallel and four cache memory RAM modules 32a, 32b, 32c and 32d connected in parallel.

Each of the tag memory RAM modules 31a, 31b, 31c and 31d and the cache memory RAM modules 32a, 32b, 32c and 32d has a function to be turned into a lower consumption power state by a RAM power control device 37 to be described later. This function is realized by consumption power mode control devices 40a, 40b, 40c, 40d, 41a, 41b, 41c and 41d provided for the RAM modules 31a, 31b, 31c, 31d, 32a, 32b, 32b and 32d, respectively. This is the same function as that provided at each of the tag memory RAM modules and cache memory RAM modules of the conventional cache memory system having a set associative constitution.

Further, the cache memory system has a tag determination circuit 33 determining whether or not a request address value requested by the processor core or the like is coincident with address data read from each of the RAM modules 31a, 31b, 31c and 31d. This tag determination circuit 33 consists of four comparators 35a, 35b, 35c and 35d and four AND circuits 36a, 36b, 36c and 36d as in the case of the conventional tag determination circuit.

More further, the cache memory system has a data selector 34 selecting only valid data from among the data read from each of the cache memory RAM modules 32a, 32b, 32c and 32d, and outputting the selected valid data to a data bus. This data selector 34 is controlled by a data selector control circuit 38 to be described later. The tag determination circuit 33 and the data selector control circuit 38 constitute data selector control unit. In addition, the cache memory system has a cash hit/miss control circuit 39, to be described later, for returning cache hit or miss to the processor core or the like which is not shown.

In the first embodiment for carrying out the invention, the constitutions and functions of the tag memory RAM modules 31a, 31b, 31c and 31d, the cache memory RAM modules 32a, 32b, 32c and 32d, the tag determination circuit 33 and the data selector 34 are the same as those of the conventional tag memory RAM modules 11a, 11b, 11c and 11d, the conventional cache memory RAM modules 12a, 12b, 12c and 12d, the conventional tag determination circuit 13 and the conventional data selector 14. No description will be, therefore, given herein. Also, since the consumption power mode control devices 40a, 40b, 40c, 40d, 41a, 41b, 41c and 41d are the same as those of the conventional power consumption mode control devices, no description will be given thereto, either.

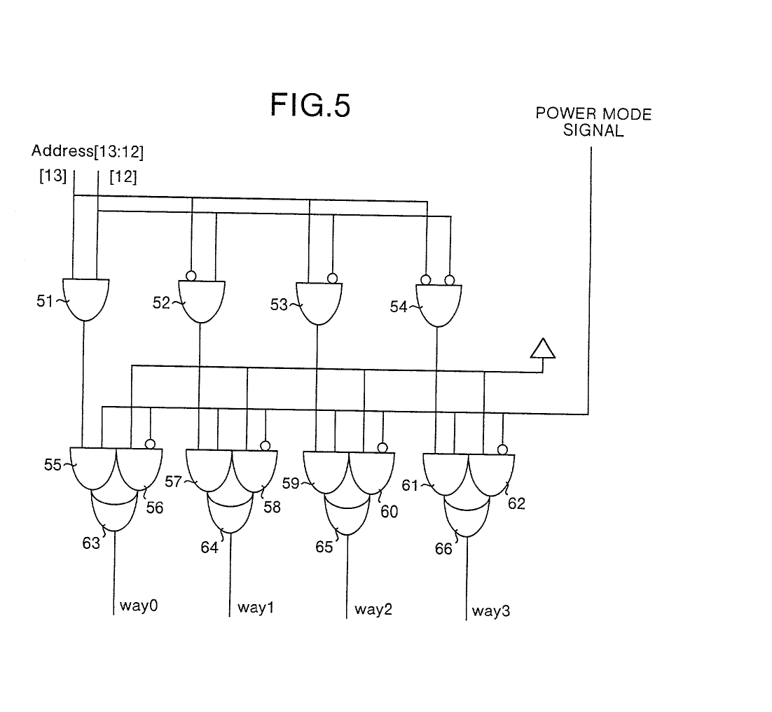

FIG. 5 is a logic circuit diagram showing an example of the RAM power control device 37. The RAM power control device 37 has twelve AND circuits 51 to 62 and four OR circuits 63 to 66.

The AND circuit 51, the AND circuit 52, the AND circuit 53 and the AND circuit 54 are supplied with, as input signals, for example, the thirteenth bit signal and twelfth bit signal among request address signals supplied from the processor core. If both the thirteenth bit signal and the twelfth bit signal are “1”, only the AND circuit 51 outputs “1”. The terminal of the AND circuit 52 into which the thirteenth bit signal is input, is low active. Due to this, if the thirteenth bit signal is “0” and the twelfth bit signal is “1”, only the AND circuit 52 outputs “1”.

Further, the terminal of the AND circuit 53 into which the twelfth bit signal is input, is low active. Due to this, if the thirteenth bit signal is “1” and the twelfth bit signal is “0”, only the AND circuit 53 outputs “1”. Both input terminals of the AND circuit 54 are low active. Due to this, if both the thirteenth bit signal and the twelfth bit signal are “0”, only the AND circuit 54 outputs “1”. It is noted that in the description of the logic circuit, the value of a signal having a relatively high potential level is “1” and the value of a signal having a relatively low potential level is “0”.

The AND circuit 55, The AND circuit 57, The AND circuit 59 and The AND circuit 61 are supplied with, input signals, power mode signals and the output signals of the AND circuit 51, the AND circuit 52, the AND circuit 53 and the AND circuit 54, respectively. If the power mode signal is “1” and the output value of the AND circuit 51 is “1”, then the output value of the AND circuit 55 becomes “1”, and the output value of the AND circuit 52 is “1”, then the output value of the AND circuit 57 becomes “1”. If the power mode signal is “1” and the output value of the AND circuit 53 is “1”, then the output value of the AND circuit 59 becomes “1”, and the output value of the AND circuit 54 is “1”, then the output value of the AND circuit 61 becomes “1”. On the other hand, if the power mode signal is “0”, all the outputs of the AND circuits 55, 57, 59 and 61 become “0”.

The AND circuit 56, AND circuit 58, AND circuit 60 and the AND circuit 62 are supplied with, as input signals, a power mode signal and a high level signal (i.e., “1”). The terminals to which power mode signal is supplied are low active in these AND circuits 56, 58, 60 and 62. Due to this, if the power mode signal is “1”, the output values of these AND circuits are “0” and if the power mode signal is “0”, the output values thereof are “1”.

The OR circuit 63 outputs an OR logic between the output value of the AND circuit 55 and the output value of the AND circuit 56. The OR circuit 64 outputs an OR logic between the output value of the AND circuit 57 and the output value of the AND circuit 58. The OR circuit 65 outputs an OR logic between the output value of the AND circuit 59 and the output value of the AND circuit 60. The OR circuit 66 outputs an OR logic between the output value of the AND circuit 61 and the output value of the AND circuit 62.

The output signal of the OR circuit 63 is, for example, supplied, as a RAM power control signal for a way 0, to the consumption power mode control devices 40a and the consumption power mode control devices 41a for controlling the consumption power of the tag memory RAM module 31a and the cache memory RAM module 32a, respectively. Likewise, the output signal of the OR circuit 64 is supplied, as a RAM power control signal for a way 1, to the consumption power mode control device 40b for the tag memory RAM module 3b and the consumption power module control device 41b for the cache memory RAM module 32a.

The output signal of the OR circuit 65 is supplied, as a RAM power control signal for a way 2, to the consumption power mode control device 40c for the tag memory RAM module 31c and the consumption power mode control device 41c for the cache memory RAM module 32c. The output signal of the OR circuit 66 is supplied, as a RAM power control signal for a way 3, to the consumption power mode control device 40d for the tag memory RAM module 31d and the consumption power mode control device 41d for the cache memory RAM module 32d.

Here, if the input RAM power control signal is “1”, each of the consumption power mode control devices 40a, 40b, 40c, 4d, 41a, 41b, 41c and 41d activates their corresponding RAM module in an ordinary state. On the other hand, if the RAM power control signal is “0”, each of the consumption power mode control devices 40a, 40b, 40c, 40d, 41a, 41b, 41c and 41d activates their corresponding RAM modules in a low consumption power state. Accordingly, if the power mode signal is “0”, the output values of the AND circuits 56, 58, 60 and 62 are “1” irrespectively of the 2-bit value of an input address. Due to this, the output values of the OR circuits 63 to 66, i.e., the values of the RAM power control signals input into the consumption power mode control devices 40a, 40b, 40c, 40d, 41a, 41b, 41c and 41d become “1”.

That is to say, all of the tag memory RAM modules 31a, 31b, 31c and 31d and the cache memory RAM modules 32a, 32b, 32c and 32d are constituted to be activated in an ordinary state and the cache memory system at this time has a set associative constitution.

On the other hand, if the power mode signal is “1”, the output value of any one of the AND circuits 51 to 54 becomes “1” based on the 2-bit value of the input address and the output value of any one of the AND circuits 55, 57, 59 and 61 becomes “1” accordingly. Therefore, the output value of any one of the OR circuits 63 to 66 becomes “1”, so that only the value of the RAM power control signal supplied to a pair of consumption power mode control devices among the consumption power mode control devices 40a, 40b, 40c and 40d and the corresponding consumption power mode control device 41a, 41b, 41c and 41d.

In other words, among the tag memory RAM modules 31a, 31b, 31c and 31d and the cache memory RAM modules 32a, 32b, 32c and 32d, only the tag memory RAM module and the cache memory RAM module corresponding to the 2-bit value of the input address are activated in an ordinary state, while the remaining RAM modules are activated in a low consumption power state. The cache memory system at this time has a direct map constitution. It is noted that the constitution of the RAM power control device 37 is not limited to the constitution of the above-stated logic circuit.

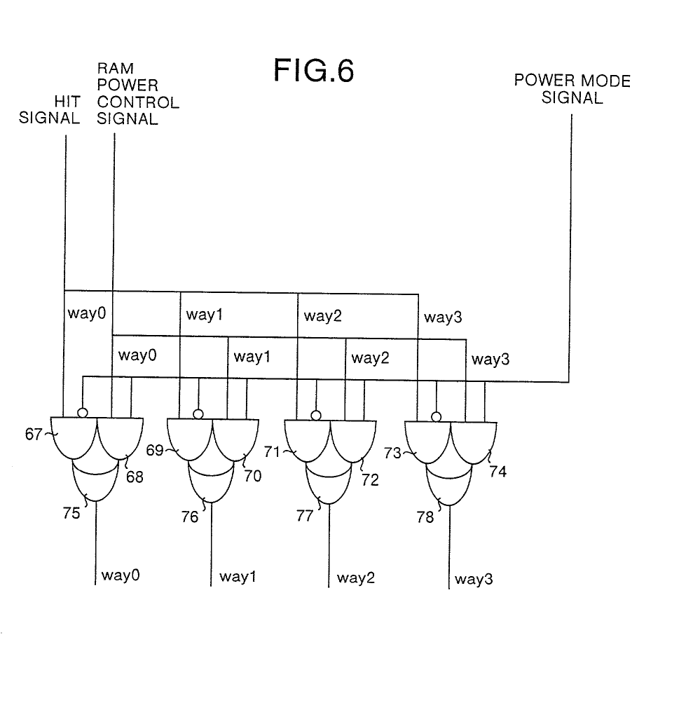

FIG. 6 is a logic circuit diagram showing an example of the data selector control circuit 38. The data selector control circuit 38 has eight AND circuits 67 to 74 and four OR circuits 75 to 78.

The AND circuit 67, The AND circuit 69, The AND circuit 71 and The AND circuit 73 are supplied with, as input signals, power mode signals and the output signals of the AND circuits 36a, 36b, 37c and 36d in the tag determination circuit 33, respectively. The terminals of the AND circuits 67, 69, 71 and 73 into which the power mode signals are input are low active. Due to this, if the power mode signal is “1”, the outputs of all the circuits become “0”. On the other hand, if the power mode signal is “0”, only the output value of the AND circuit on a way on which the output signals of each of the AND circuits 36a, 36b, 36c and 36d in the tag determination circuit 33 are “1”.

The AND circuit 68, The AND circuit 70, The AND circuit 72 and The AND circuit 74 are supplied with, as input signals, power mode signals and RAM power control signals outputted from the OR circuits 63, 64, 65 and 66 in the RAM power control device 37, respectively. If the power mode signal is “1”, only the output value of the AND circuit on the way on which the RAM power control signal is “1”, becomes “1”. On the other hand, if the power mode signal is “0”, the outputs of all the AND circuits become “0”.

The OR circuit 75 outputs an OR logic between the output value of the AND circuit 67 and the output value of the AND circuit 68. The OR circuit 76 outputs an OR logic between the output value of the AND circuit 69 and the output value of the AND circuit 70. The OR circuit 77 outputs an OR logic between the output value of the AND circuit 71 and the output value of the AND circuit 72. The OR circuit 78 outputs an OR logic between the output value of the AND circuit 73 and the output value of the AND circuit 74.

The output signals of, for example, the OR circuit 75, the OR circuit 76, the OR circuit 77 and the OR circuit 78 are supplied, as data select signals for selecting one of the data read from each of the cache memory RAM modules 32a, 32b, 32c and 32d on the ways 0, 1, 2 and 3, to the data selector 34.

Therefore, if the power mode signal is “0” (i.e., the cache memory system has a set associative constitution), only the way data among the data read from each of the cache memory RAM modules 32a, 32b, 32c and 32d, on the way for which the request address is determined, by the tag determination circuit 33, to be coincident with valid address data read from each of the tag memory RAM modules 31a, 31b, 31c and 31d, and the data is outputted to the data bus.

If the power mode signal is “1” (i.e., the cache memory system has a direct map constitution), only the data among the data read from each of the cache memory RAM modules 32a, 32b, 32c and 32d, which data is read from the cache memory RAM module activated in an ordinary state by the RAM power control signal, and outputted to the data bus. It is noted that the constitution of the data selector control circuit 38 is not limited to the constitution of the above-stated logic circuit.

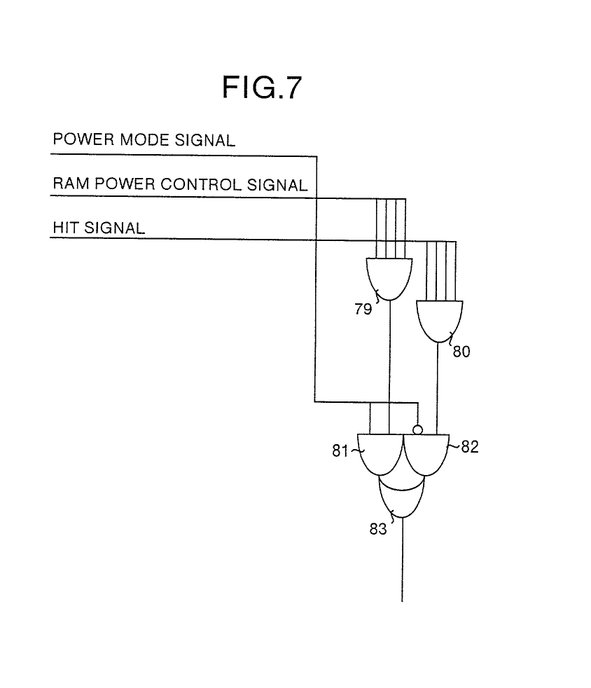

FIG. 7 is a logic circuit diagram showing an example of the cache hit/miss control circuit 39. The cache hit/miss control circuit 39 has four AND circuits 79 to 82 and one OR circuit 83. The AND circuit 81 is supplied with, as input signals, a power mode signal and the output signal of the AND circuit 79 inputting RAM power control signals for each of the ways. The AND circuit 82 is supplied with, as input signals, a power mode signal and the output signal of the AND circuit 80 inputting the output signals of each of the AND circuits 36a, 36b, 36c and 36d in the tag determination circuit 33. The OR circuit 83 outputs an OR logic between the output value of the AND circuit 81 and the output value of the AND circuit 82.

If the power mode signal is “0” (i.e., the cache memory system has a set associative constitution), the output value of the AND circuit 81 becomes “0”. At this moment, the terminal of the AND circuit 82 into which the power mode signal is input is low active. Due to this, the output value of the AND circuit 82 is determined by the output value of the AND circuit 80. Accordingly, the output value of the OR circuit 83 which is the output value of the cache hit/miss control circuit 39 is determined by the output value of the tag determination circuit 33. On the other hand, if the power mode signal is “1” (i.e., the cache memory system has a direct map constitution), the output value of the AND circuit 82 becomes “0” but the output value of the AND circuit 81 is determined by the output value of the AND circuit 79. Accordingly, the output value of the cache hit/miss control circuit 39 is determined by the value of the RAM power control signal. It is noted that the constitution of the cache hit/miss control circuit 39 is not limited to the constitution of the above-stated logic circuit.

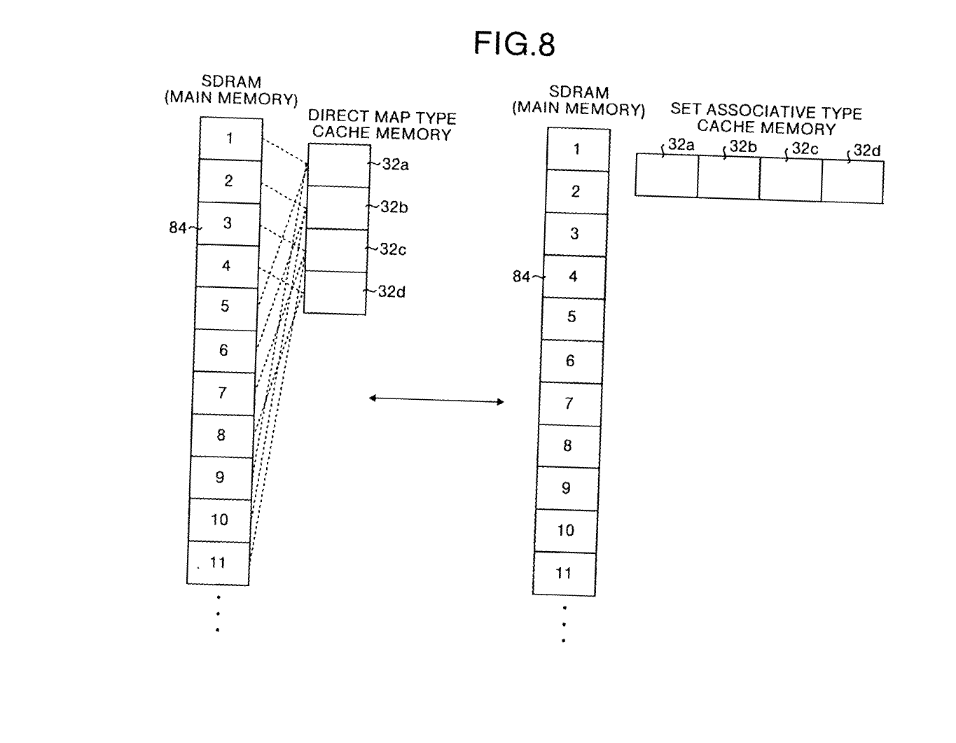

FIG. 8 is a typical view for describing the concept of the memory regions of the cache memory system according to the first embodiment for carrying out the invention. If it is assumed that the main memory 84 of an SDRAM or the like is divided into a plurality of regions and that the cache memory system is activated with a set associative constitution, then the regions of the main memory 84 stored in each of the cache memory RAM modules 32a, 32b, 32c and 32d are the first, second, third regions and on, i.e., the entire regions of the main memory 84 are stored.

On the other hand, if the cache memory system is activated with a direct map constitution, the cache memory RAM module 32a, for example, stores the first, fifth, ninth, thirteenth regions and on of the main memory 84. Likewise, the regions of main memory 84 stored in the cache memory RAM module 32b are the second, sixth, tenth, fourteenth regions and on. Those stored in the cache memory RAM module 32c are the third, seventh, eleventh, fifteenth regions and on. Those stored in the cache memory RAM module 32d are the fourth, eighth, twelfth, sixteenth regions and on.

Next, the function of the cache memory system according to the first embodiment for carrying out the invention will be described. If the power mode signal is “0”, i.e., the cache memory system is activated with a set associative constitution, then the data read operation and data write operation of the cache memory system are the same as those of the conventional cache memory system of a set associative constitution.

If the power mode signal is “1”, i.e., the cache memory system is activated with a direct map constitution, then only one tag memory RAM module and only one cache memory RAM module on any one of the ways are activated in an ordinary state based on, for example, the thirteenth bit and twelfth bit values of an input address in both the data read operation and the data write operation of the cache memory system. As for the remaining three ways, both the tag memory RAM modules and the cache memory RAM modules are turned into a lower consumption power state. When reading data, the data read from the cache memory RAM module in a low consumption power state is determined to be invalid by the data selector 34 based on the RAM power control signal.

According to the first embodiment for carrying out the invention stated above, if the power mode signal is in a high hit ratio mode, the cache memory system is activated with an n-way set associative constitution. On the other hand, if the power mode signal is in a low consumption power mode, the cache memory system is activated with a 1-way direct map constitution. Therefore, it is possible to select a case where the performance of the arithmetic processing unit is prioritized even if consumption power is high and a case where low consumption power is prioritized, according to a user or a peripheral environment such as an application in use.

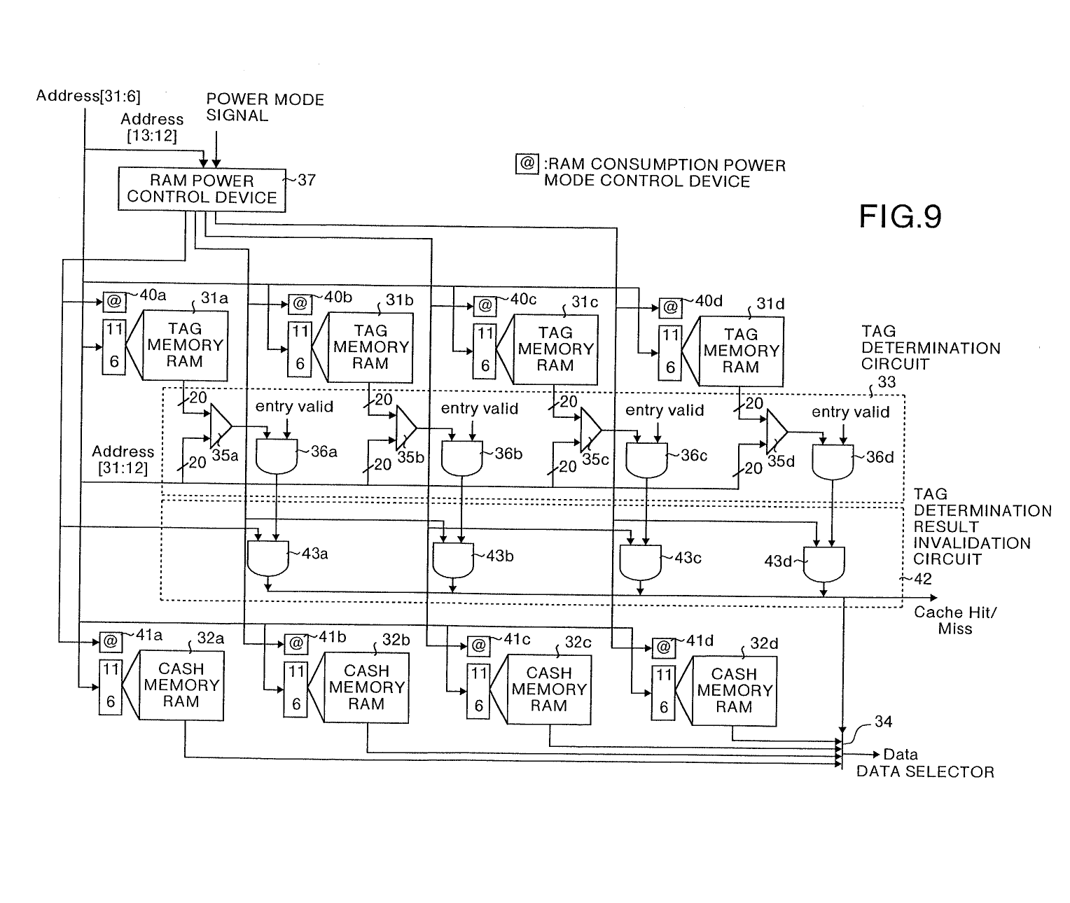

FIG. 9 is a block diagram showing an example of a cache memory system according to the second embodiment for carrying out the present invention. The cache memory system in the second embodiment differs from the cache memory system in the first embodiment (see FIG. 4) as follows. First, a tag determination result invalidation circuit 42 instead of the data selector control circuit 38, and tag data selector control unit is constituted out of a tag determination circuit 33 and the tag determination result invalidation circuit 42.

Second, for the purpose of returning cache hit or miss to a processor core or the like, not shown, the output of the tag determination result invalidation circuit 42 instead of that of the cache hit/miss control circuit 39 is returned. Since the other constitution is the same as that of the first embodiment for carrying out the invention, the same constituent elements as those in the first embodiment are denoted by the same reference symbols and will not be described herein.

If the cache memory system is activated with a direct map constitution, the tag determination result invalidation circuit 42 invalidates address data and an entry valid flag read from a tag memory RAM module in a low consumption power state. The tag determination invalidation circuit 42 has four AND circuits 43a, 43b, 43c and 43d. The AND circuit 43a on a way 0 is supplied with a RAM power control signal for the way 0 and the output signal of the AND circuit 36a in the tag determination circuit 33.

Likewise, the AND circuits 43b on a way 1, the AND circuit 43c on a way 2 and the AND circuit 43d on a way 3 are supplied with a RAM power control signal for the way 1 and the output signal of the AND circuit 36b in the tag determination circuit 33, a RAM power control signal for the way 2 and the output signal of the AND circuit 36c in the tag determination circuit 33, and a RAM power control signal for the way 3 and the output signal of the AND circuit 36d in the tag determination circuit 33, respectively.

Next, the function of the cache memory system according to the second embodiment for carrying out the invention will be described. The function is the same as that of the cache memory system according to the first embodiment for carrying out the invention except that if the power mode signal is “1”, i.e. the cache memory system is activated with a direct map constitution, data read from the cache memory RAM module in a low consumption power state is invalidated by the data selector 34 based on the output signal of the tag determination result invalidation circuit 42 when reading the data.

According to the second embodiment for carrying out the invention, if the power mode signal is in a high hit ratio mode, the cache memory system is activated as a system having an n-way set associative constitution. On the other hand, if the power mode signal is in a low consumption power mode, the cache memory system is activated as a system having a 1-way direct map constitution. Due to this, it is possible to select a case where the performance of the arithmetic processing unit is prioritized even if consumption power is high and a case where low consumption power is prioritized, according to a user or a peripheral environment such as an application in use.

The first and second embodiments for carrying out the invention relate to the cache memory system capable of dynamically switching a constitution between the set associative constitution and the direct map constitution using the power mode signal. A cache memory system according to the third embodiment for carrying out the invention, by contrast, has a direct map constitution so as to realize low power consumption. It is noted that the same constituent elements in the third embodiment for carrying out the invention as those in the first or second embodiment for carrying out the invention are denoted by the same reference symbols and will not be described herein.

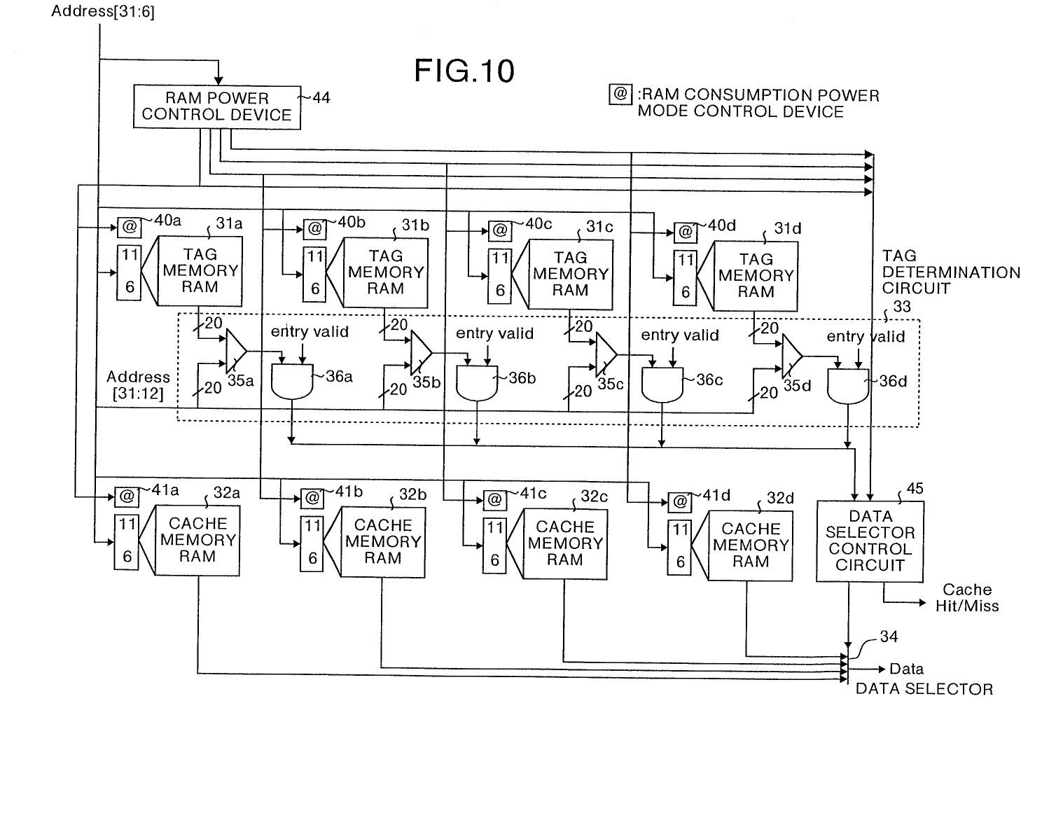

FIG. 10 is a block diagram showing an example of a cache memory system according to the third embodiment for carrying out the invention. This cache memory system is a system having the same constitution as that of the cache memory system in the first embodiment for carrying out the invention shown in FIG. 4, which constitution has a direct map constitution. The cache memory system is constituted such that a RAM power control device 44 and a data selector control circuit 45 do not depend on a power mode signal. Also, the cache memory system is constituted to return cache hit or miss to a processor core or the like without depending on a power mode signal.

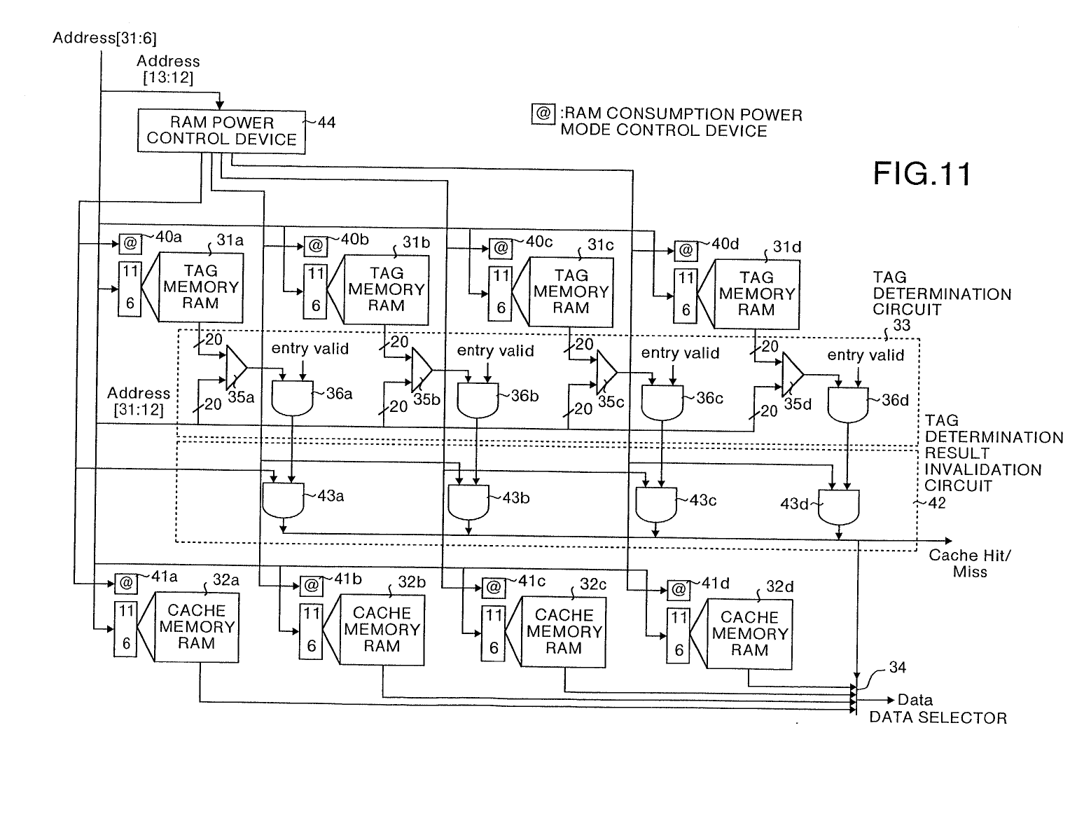

FIG. 11 is a block diagram showing another example of a cache memory system according to the third embodiment for carrying out the invention. This cache memory system is a system having the same constitution as that of the cache memory system in the second embodiment for carrying out the invention shown in FIG. 9, which system has a direct map constitution. The cache memory system is constituted such that a RAM power control device 44 does not depend on a power mode signal.

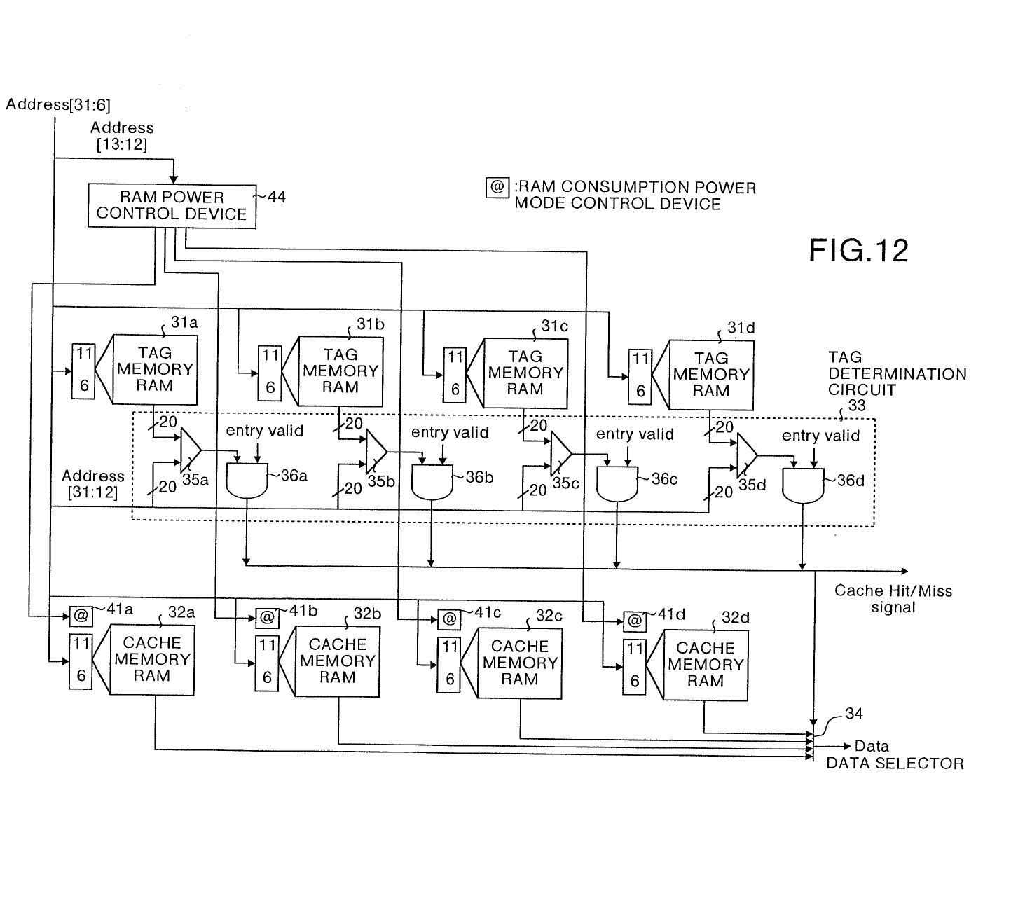

FIG. 12 is a block diagram showing a modified example of the cache memory system shown in FIG. 10. In this cache memory system, only the cache memory RAM modules 32a, 32b and 32c are subjected to be turned into a lower consumption power state in the cache memory system shown in FIG. 10.

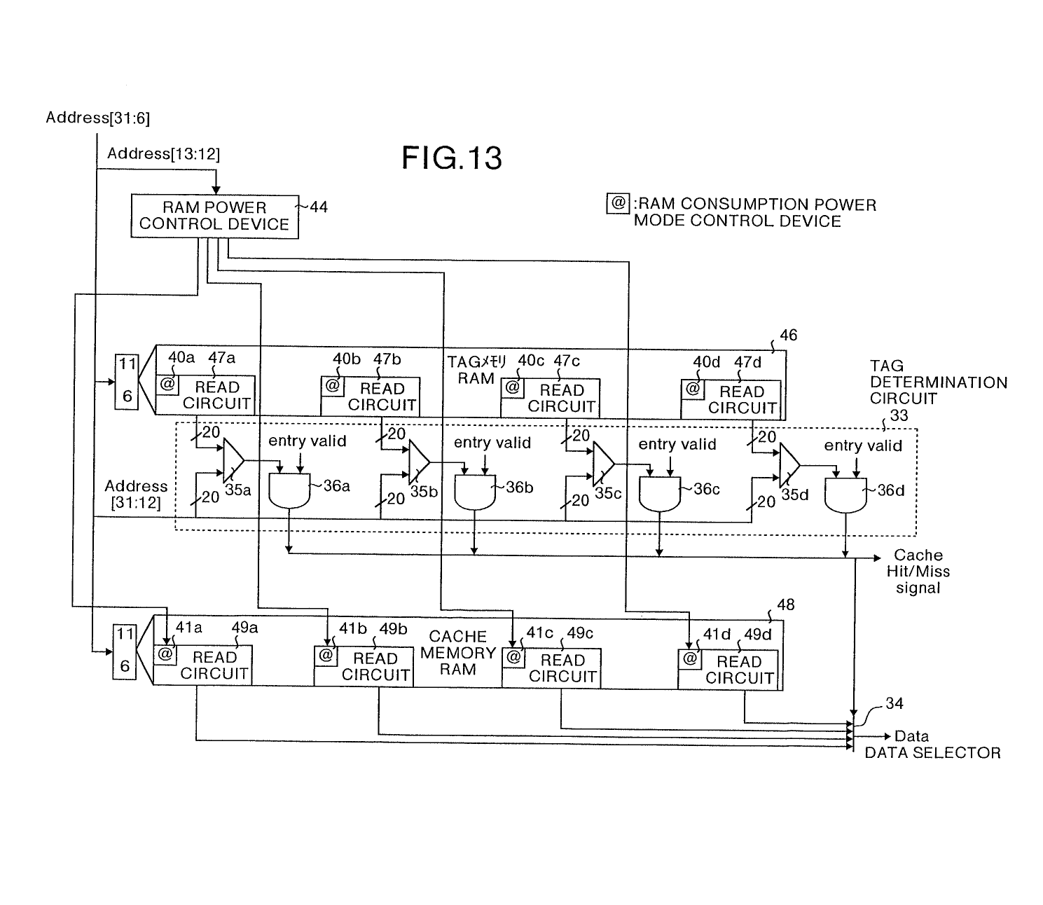

FIG. 13 is a block diagram showing a modified example of the cache memory system shown in FIG. 10. In this cache memory system, a tag memory RAM module 46 and a cache memory RAM module 48 each divided into four regions are provided instead of the four tag memory RAM modules 31a, 31b, 31c and 31d and the four cache memory RAM modules 32a, 32b, 32c and 32d in the cache memory system shown in FIG. 10.

The tag memory RAM module 46 is provided with read circuits 47a, 47b, 47c and 47d in each of the regions. Likewise, the cache memory RAM module 48 is provided with read circuits 49a, 49b, 49c and 49d in each of the regions. The states of these read circuits 47a, 47b, 47c, 47d, 49a, 49b, 49c and 49d are switched between an ordinary state and a low consumption power state by a RAM power control device 44.

According to the third embodiment for carrying out the invention stated above, in any example, only one way is activated in an ordinary state based on the value of the request address and the remaining ways are turned into a low consumption power state. Due to this, it is possible to reduce the consumption power of the cache memory system.

According to the present invention, n tag memory RAM sections each capable of switching a state between an ordinary state and a low consumption power state are connected in parallel; n cache memory RAM sections each capable of switching a state between the ordinary state and the low consumption power state are connected in parallel; if a power mode signal is in a high hit ratio mode, the cache memory system has A set associative constitution, in which all the tag memory RAM sections and all the cache memory RAM sections are activated in the ordinary state; and, on the other hand, if the power mode signal is in a low consumption power mode, the cache memory system has a 1-way direct map constitution, in which only one of the tag memory RAM sections and only one of the cache memory RAM sections corresponding to the tag memory RAM section are activated in the ordinary state and the remaining tag memory RAM sections and cache memory RAM sections are turned into the low consumption power state based on the value of the request address. Due to such an arrangement, if the power mode signal is in a high hit ration mode, the cache memory system is activated as a system having an n-way set associative constitution and if the power mode signal is in a low consumption power mode, the cache memory system is activated as a system having a 1-way direct map constitution. It is, therefore, possible to select a case where the performance of the arithmetic processing unit is prioritized even if power consumption is high and a case where low consumption power is prioritized, according to a user or a peripheral environment such as an application in use.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A cache memory system comprising:
tag memory sections in number n;
cache memory sections in number n each capable of switching a state between an ordinary state and a lower power consumption state;
a power control unit which controls switching of a way constitution to either an n-way constitution, in which all the cache memory sections are activated in the ordinary state based on a power mode signal, or a 1-way constitution, in which only one of the cache memory sections is activated in the ordinary state and the remaining cache memory sections are turned into the low consumption power state based on a value of an input request address;
a data selector which selects only data read from any one of the cache memory sections when reading the data; and
a data selector control unit which controls the data selector so as to select only data read from the cache memory section corresponding to the value of the request address in case of the n-way constitution and to select only data read from the cache memory section in the ordinary state in case of the 1-way constitution.

2. The cache memory system according to claim 1, wherein the power control unit is constituted out of a logic circuit generating a signal for controlling an operation state of each of the cache memory sections based on the value of the request address and a value of the power mode signal.

3. The cache memory system according to claim 1, further comprising:
a tag determination circuit which determines whether or not the address data read from each of the tag memory section is coincident with the value of the request address; and
a data selector control circuit which controls so as to select any one of data read from each of the cache memory sections based on a determination result of the tag determination circuit, a value of the power mode signal and a control content of the power control unit.

4. The cache memory system according to claim 1, wherein the n cache memory sections correspond to individual n regions divided from one module.

5. A cache memory system comprising:
tag memory sections in number n capable of switching a state between an ordinary state and a low consumption power state;
cache memory sections in number n each capable of switching a state between the ordinary state and the low consumption power state;
a power control unit which controls switching of a way constitution to either an n-way constitution, in which all the tag memory sections and all the cache memory sections are activated in the ordinary state based on a power mode signal, or a 1-way constitution, in which only one tag memory section and only one cache memory section corresponding to the tag memory section are activated in the ordinary state and the remaining tag memory sections and cache memory sections are turned into the low consumption power state based on a value of an input request address;
a data selector which selects only data read from any one of the cache memory sections when reading the data; and
a data selector control unit which controls the data selector as to select only data read from the cache memory section corresponding to the value of the request address in case of the n-way constitution and to select only data read from the cache memory section in the ordinary state in case of the 1-way constitution.

6. The cache memory system according to claim 5, wherein the power control unit is constituted out of a logic circuit generating a signal for controlling an operation state of each of the tag memory sections and each of the cache memory sections based on the value of the request address and a value of the power mode signal.

7. The cache memory system according to claim 5, further comprising:
a tag determination circuit which determines whether or not the address data read from each of the tag memory section is coincident with the value of the request address; and
a data selector control circuit which controls so as to select any one of data read from each of the cache memory sections based on a determination result of the tag determination circuit, a value of the power mode signal and a control content of the power control unit.

8. The cache memory system according to claim 5, wherein the data selector control unit includes
a tag determination circuit which determines whether or not the address data read from each of the tag memory sections is coincident with the value of the request address; and
a tag determination result invalidation circuit which invalidates a determination result of the tag determination circuit if the address data read from the tag memory section in the low consumption power state is coincident with the value of the request address.

9. The cache memory system according to claim 5, wherein the n cache memory sections correspond to individual n regions divided from one module.

10. The cache memory system according to claim 5, wherein the n tag memory sections correspond to individual n regions divided from one module.

11. A cache memory system comprising:
tag memory sections in number n which are connected in parallel;
cache memory sections in number n each capable of switching a state between an ordinary state and a low consumption power state;
a power control unit which controls an operation state of each of the cache memory sections so that only one cache memory section among the cache memory sections is activated in the ordinary state and the remaining cache memory sections are turned into the low consumption power state based on a value of an input request address;
a data selector which selects only data read from any one of the cache memory sections when reading the data; and
a data selector control unit which controls the data selector so as to select only data read from the cache memory section turned into the ordinary state by the power control unit.

12. The cache memory system according to claim 11, wherein the power control unit is constituted out of a logic circuit generating a signal for controlling an operation state of each of the cache memory sections based on the value of the request address.

13. The cache memory system according to claim 11, wherein the data selector control unit includes
a tag determination circuit which determines whether or not the address data read from each of the tag memory section is coincident with the value of the request address; and
a data selector control circuit which controls so as to select any one of data read from the cache memory sections based on a determination result of the tag determination circuit and a control content of the power control unit.

14. The cache memory system according to claim 11, wherein the n cache memory sections correspond to individual n regions divided from one module.

15. A cache memory system comprising:
tag memory sections in number n each capable of switching a state between an ordinary state and a low consumption power state;
cache memory sections in number n each capable of switching a state between the ordinary state and the low consumption power state;
a power control unit which controls an operation state of each of the tag memory sections and each of the cache memory section so that only one tag memory section and only one cache memory section corresponding to the tag memory section among the tag memory sections and the cache memory sections are activated in the ordinary state and the remaining tag memory sections and cache memory sections are turned into the low consumption power state based on a value of an input request address;
a data selector which selects only data read from any one of the cache memory sections when reading the data; and
a data selector control unit which controls the data selector so as to select only data read from the cache memory section turned into the ordinary state by the power control device.

16. The cache memory system according to claim 15, wherein the power control unit is constituted out of a logic circuit generating a signal for controlling an operation state of each of the tag memory sections and each of the cache memory section based on the value of the request address.

17. The cache memory system according to claim 15, wherein the data selector control unit includes
a tag determination circuit which determines whether or not the address data read from each of the tag memory section is coincident with the value of the request address; and
a data selector control circuit which controls so as to select any one of data read from the cache memory sections based on a determination result of the tag determination circuit and a control content of the power control unit.

18. The cache memory system according to claim 15, wherein the data selector control unit includes
a tag determination circuit which determines whether or not the address data read from each of the tag memory sections is coincident with the value of the request address; and
a tag determination result invalidation circuit which invalidates a determination result of the tag determination circuit if the address data read from the tag memory section in the low consumption power state is coincident with the value of the request address.

19. The cache memory system according to claim 15, wherein the n cache memory sections correspond to individual n regions divided from one module.

20. The cache memory system according to claim 15, wherein the n tag memory sections correspond to individual n regions divided from one module.
